(19) United States
(12) Patent Application Publication
(10) Pub. No.: US 2018/0259924 A1
(43) Pub. Date: Sep. 13, 2018

(54) Bus Control System For Home Appliance

(71) Applicant: Tyco Electronics (Shanghai) Co. Ltd., Shanghai (CN)

(72) Inventors: Mingjie Fan, Shanghai (CN); Yulin Feng, Shanghai (CN); Yuming Song, Shanghai (CN)

(73) Assignee: Tyco Electronics (Shanghai) Co. Ltd., Shanghai (CN)

(21) Appl. No.: 15/979,552

(22) Filed: May 15, 2018

Related U.S. Application Data
(63) Continuation of application No. PCT/IB2016/056874, filed on Nov. 15, 2016.

(30) Foreign Application Priority Data
Nov. 17, 2015 (CN) 201510788789.6

(51) Int. Cl. G05B 19/042; H04L 12/28

(52) U.S. Cl. CPC G05B 19/0423; H04L 12/2803; G05B 2219/2642; G05B 2219/2633; G05B 2219/2613; H04L 2012/285

(57) ABSTRACT

A bus control system for a home appliance comprises a main controller connected to a bus, a plurality of universal modules each connected to the bus, and a plurality of virtual function modules each communicated with the bus through the main controller to perform a corresponding function. A plurality of loads of the home appliance are each physically connected to a nearest one of the plurality of universal modules. Each of the virtual function modules obtains data of each of loads related to the corresponding function through the bus and generates corresponding control instructions based on the obtained data of each of the loads. The plurality of universal modules receive the control instructions generated by each of the virtual function modules through the bus and directly control respective loads based on the received control instructions.

### CROSS-REFERENCE TO RELATED APPLICATIONS

This application is a continuation of PCT International Application No. PCT/IB2016/056874, filed on Nov. 15, 2016, which claims priority under 35 U.S.C. § 119 to Chinese Patent Application No. 201510788789.6, filed on Nov. 17, 2015.

### FIELD OF THE INVENTION

The present invention relates to a bus control system and, more particularly, to a bus control system for a home appliance.

### BACKGROUND

As Internet of Things technology develops and consumption trends change, conventional control system design for home appliances has evolved from separate components to a modular design. A modular design is capable of meeting varied requirements and shortens a time period from product design to market. The present modular designs are generally function-oriented; the designs integrate controlling and executing a plurality of loads, including execution components and sensing components, related to a corresponding function into one module. Integrating the function into one module results in convenient module testing, intuitive addition and reduction of functions, and easy operation.

In such a modular design, however, multiple loads related to the same function may be far away from each other within the home appliance, causing a complex wiring in a wiring harness. Further, one load is not permitted to be shared by multiple function modules, leading to a high cost of manufacturing the system especially in cases in which functions are not allowed to be divided completely.

A conventional control system for a home appliance, such as a washer, is shown in FIG. 1. The control system for a washer comprises a main controller 1′, three function modules 10′, 20′ and 30′ and a plurality of loads.

The three function modules 10′, 20′ and 30′, as shown in FIG. 1, include a water-level controlling module 10′ configured to control water level in the washer, a drying module 20′ configured to dry clothes in the washer, and a washing module 30′ configured to wash clothes in the washer.

The plurality of loads, as shown in FIG. 1, include a water inlet valve 11′, a water level sensor 01′, a temperature sensor 21′, a drying heater 22′, a drying fan 23′, a gate lock 02′, a humidity sensor 24′, a water heater 31′, a draining pump 12′, a water temperature sensor 32′ and a motor 33′.

As shown in FIG. 1, the water-level controlling module 10′, the drying module 20′, and the washing module 30′ are connected to the main controller 1′ respectively. The water inlet valve 11′ and the draining pump 12′ are connected to the water-level controlling module 10′. The temperature sensor 21′, the drying heater 22′, the drying fan 23′ and the humidity sensor 24′ are connected to the drying module 20′. The water heater 31′, the water temperature sensor 32′ and the motor 33′ are connected to the washing module 30′. The gate lock 02′ related to the water-level controlling module 10′, the drying module 20′, and the washing module 30′ is connected to the main controller 1′ separately. The water level sensor 01′ related to the water-level controlling module 10′ and the washing module 30′ is also connected to the main controller 1′ separately. All the loads of the washer shown in FIG. 1 are classified according to their respective functions to be achieved and are connected to the respective function modules. Loads 01′ and 02′ related to multiple function modules are connected to the main controller 1′ separately.

The draining pump 12′, as shown in FIG. 1, is far from the water-level controlling module 10′, requiring relatively long connecting wires therebetween and thus an inconvenient connection, which leads to a complex relationship in the wiring harness. Additionally, loads 01′ and 02′ related to multiple function modules are connected to the main controller 1′ separately and are not allowed to be shared by multiple function modules, which destroys encapsulation and independence characteristics of each function module and leads to difficulty in maintenance and development of the control system.

### SUMMARY

A bus control system for a home appliance comprises a main controller connected to a bus, a plurality of universal modules each connected to the bus, and a plurality of virtual function modules each communicated with the bus through the main controller to perform a corresponding function. A plurality of loads of the home appliance are each physically connected to a nearest one of the plurality of universal modules. Each of the virtual function modules obtains data of each of loads related to the corresponding function through the bus and generates corresponding control instructions based on the obtained data of each of the loads. The plurality of universal modules receive the control instructions generated by each of the virtual function modules through the bus and directly control respective loads based on the received control instructions.

### BRIEF DESCRIPTION OF THE DRAWINGS

The invention will now be described by way of example with reference to the accompanying Figures, of which:

FIG. 1 is a block diagram of a conventional control system for a washer;

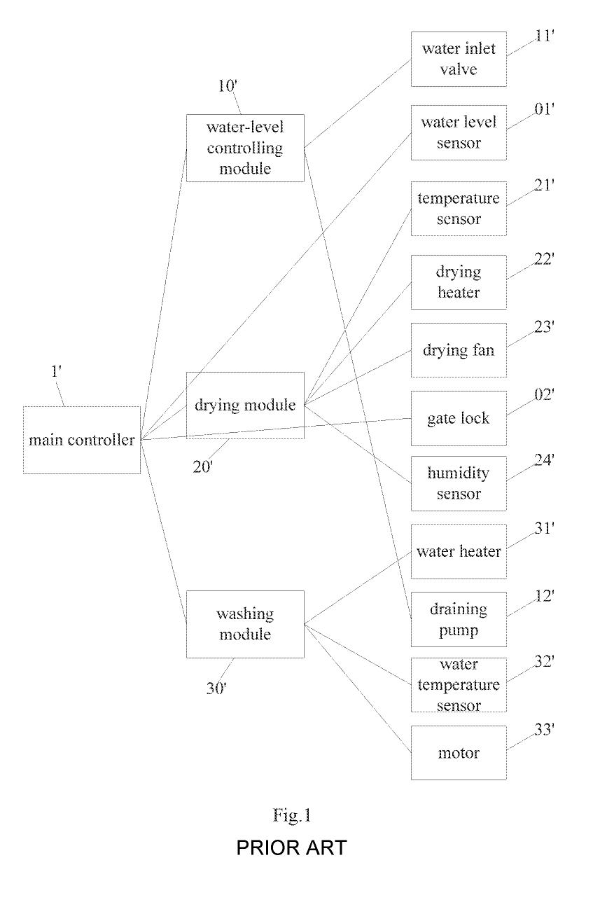

FIG. 2 is a block diagram of a main controller, a plurality of universal modules, and a plurality of loads of a bus control system according to an embodiment; and

FIG. 3 is a block diagram of the main controller, the plurality of universal modules, the plurality of loads, and a plurality of virtual function modules of the bus control system.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

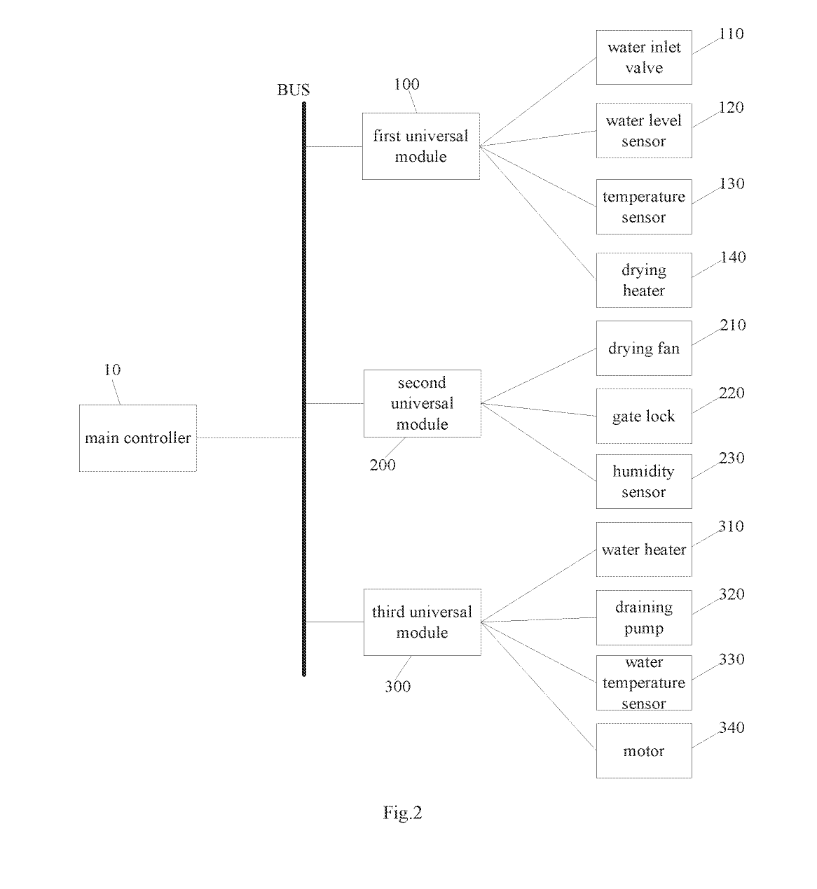

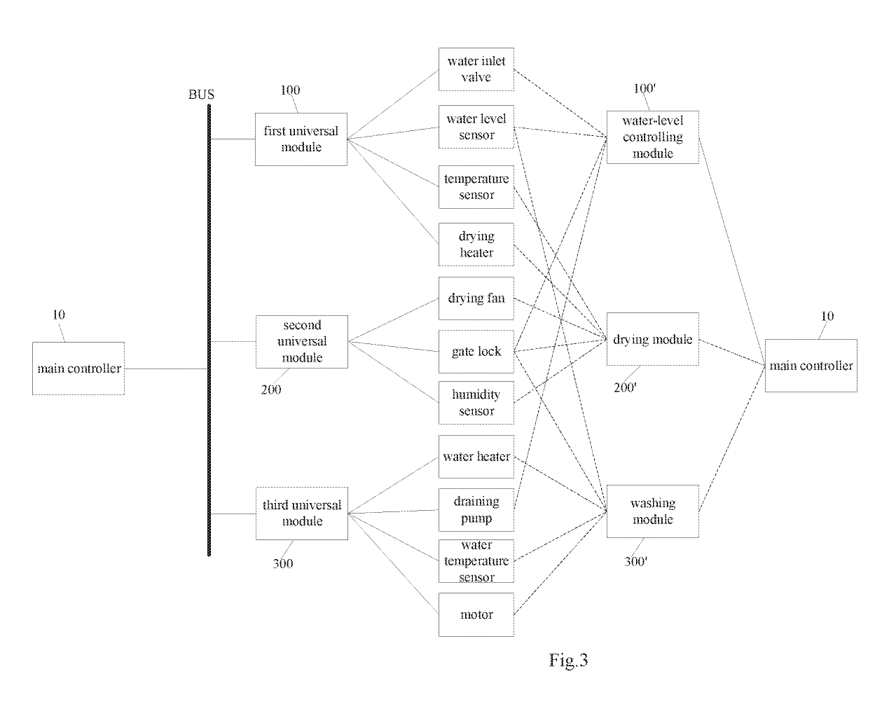

A bus control system for a home appliance is shown in FIGS. 2 and 3. In the shown embodiment, the home appliance is a washer. In other embodiments, the home appliance may be any other home appliance such as a refrigerator or a dishwasher. The bus control system comprises a main controller 10, a plurality of universal modules 100, 200 and 300, and a plurality of virtual function modules 100′, 200′, and 300′.

The plurality of universal modules 100, 200 and 300 are modules in the form of hardware or in the form of a combination of hardware and software. The plurality of virtual function modules 100′, 200′, and 300′ are in the form of software. Modules in the form of software are each a set of program instructions stored on a non-transitory computer-readable medium, such as a ROM or RAM memory of a computer. A processor executes the program instructions of the modules to perform the functions of the modules described below, including the virtual function modules 100′, 200′, 300′ and the universal modules 100, 200, 300 in some embodiments.

The main controller 10, as shown in FIGS. 2 and 3, is connected to the bus. Each of universal modules 100, 200, 300 is connected to the bus. Loads 110, 120, 130, 140, 210, 220, 230, 310, 320, 330 and 340 of the home appliance are physically connected to the nearest one of the universal modules 100, 200, or 300. In the embodiment shown in FIGS. 2 and 3, the bus control system includes three universal modules: a first universal module 100, a second universal module 200, and a third universal module 300. In other embodiments, the number of the universal modules may vary according to an application and, in general, the number of the universal modules is not greater than the number of the virtual function modules.

In the embodiment shown in FIGS. 2 and 3, the loads of the bus control system for a washer include a water inlet valve 110, a water level sensor 120, a temperature sensor 130, a drying heater 140, a drying fan 210, a gate lock 220, a humidity sensor 230, a water heater 310, a draining pump 320, a water temperature sensor 330 and a motor 340. For the loads of the washer, the water inlet valve 110, the drying heater 140, the drying fan 210, the gate lock 220, the water heater 310, the draining pump 320 and the motor 340 belong to execution components, and the water level sensor 120, the temperature sensor 130, the humidity sensor 230 and the water temperature sensor 330 belong to sensing components.

The water inlet valve 110, the water level sensor 120, the temperature sensor 130 and the drying heater 140 are physically located near the first universal module 100. The drying fan 210, the gate lock 220 and the humidity sensor 230 are physically located near the second universal module 200. The water heater 310, the draining pump 320, the water temperature sensor 330 and the motor 340 are physically located near the third universal module 300. The water inlet valve 110, the water level sensor 120, the temperature sensor 130 and the drying heater 140 are connected by wires to the first universal module 100. The drying fan 210, the gate lock 220 and the humidity sensor 230 are connected by wires to the second universal module 200. The water heater 310, the draining pump 320, the water temperature sensor 330 and the motor 340 are connected by wires to the third universal module 300.

Each of the virtual function modules 100′, 200′, 300′, as shown in FIG. 3, communicates with the bus through the main controller 10 to perform a corresponding function. The virtual function modules 100′, 200′ and 300′ include a water-level controlling module 100′ configured to provide a water level controlling function for controlling water level in the washer, a drying module 200′ configured to provide a drying function for drying clothes in the washer and a washing module 300′ configured to provide a washing function for washing clothes in the washer.

Each of the virtual function modules 100′, 200′ and 300′ obtains data of each of loads related to the corresponding function through the bus and generates respective control instructions based on the obtained data of each of the loads. The plurality of universal modules 100, 200 and 300 receive the control instructions generated by each of the virtual function modules 100′, 200′, 300′ through the bus and directly control respective loads based on the received control instructions.

As shown in FIGS. 2 and 3, at least some of the loads 120 and 220 of the home appliance are shared by at least two different virtual function modules 100′, 200′, 300′. The water level sensor 120 is shared by the water-level controlling module 100′ and the washing module 300′. The gate lock 220 is shared by the water-level controlling module 100′, the drying module 200′, and the washing module 300′.

The water-level controlling module 100′ obtains data of the water inlet valve 110, water level sensor 120, gate lock 220 and draining pump 320 through the bus and generates respective control instructions based on the obtained data. The first, second and third universal modules 100, 200 and 300 receive control instructions generated by the water-level controlling module 100′ through the bus, and directly control the water inlet valve 110, the gate lock 220 and the draining pump 320 based on the received control instructions, so as to control the water level in the washer.

The drying module 200′ obtains data of the temperature sensor 130, drying heater 140, drying fan 210, gate lock 220 and humidity sensor 230 through the bus and generates respective control instructions based on the obtained data. The first and the second universal modules 100 and 200 receive control instructions generated by the drying module 200′ through the bus, and directly control the drying heater 140, the drying fan 210 and the gate lock 220 based on the received control instructions, so as to dry clothes in the washer.

The washing module 300′ obtains data of the water level sensor 120, gate lock 220, water heater 310, water temperature sensor 330 and motor 340 through the bus and generates respective control instructions based on the obtained data. The first, the second and the third universal modules 100, 200 and 300 receive control instructions generated by the washing module 300′ through the bus, and directly control the gate lock 220, the water heater 310 and the motor 340 based on the received control instructions, so as to wash clothes in the washer.

In the bus control system for a home appliance shown in FIGS. 2 and 3, by utilizing universal control modules 100, 200, 300, in hardware, loads are connected to a nearest universal control module 100, 200, 300; such a design reduces the difficulties in designing of the system wiring harness and assembly. Through the universal modules 100, 200, 300, states of each of loads and the sensing signals are all transmitted on the bus and may be obtained and controlled by the main controller 10 or by each of the universal modules 100, 200, 300. Bus access based on events and distributed processing technology based on a network are integrated.

In software, as shown in FIGS. 2 and 3, since communicated information of each of the loads is transmitted on the bus, each of the virtual modules 100′, 200′, and 300′ read reported data of related loads through the bus, and each of the loads may execute the operation instructions generated by the virtual modules 100′, 200′, and 300′. In light of the software control for the system, there are still three function modules 100′, 200′, and 300′ in the system; design and development may be performed completely following the process for function modules 100′, 200′, and 300′, facilitating encapsulation and migration of the function modules 100′, 200′, and 300′. It is possible to add or reduce loads in each virtual function module 100′, 200′, 300′ according to various requirements without modifying the hardware, thereby improving the flexibility of the bus control system. Furthermore, due to the modification to the connecting architecture, any loads may be shared by multiple function modules 100′, 200′, and 300′ simultaneously, thus breaking a bottleneck of one-to-one relationship between the loads and the function modules 100′, 200′, and 300′. Breaking this bottleneck is critical to the application analysis in big data in the future and also increases functions and additional value of each function module 100′, 200′, and 300′ without increasing cost of hardware.

What is claimed is:

1. A bus control system for a home appliance, comprising:
a main controller connected to a bus;
a plurality of universal modules each connected to the bus, a plurality of loads of the home appliance are each physically connected to a nearest one of the plurality of universal modules; and
a plurality of virtual function modules each communicated with the bus through the main controller to perform a corresponding function, each of the virtual function modules obtains data of each of loads related to the corresponding function through the bus and generates corresponding control instructions based on the obtained data of each of the loads, and the plurality of universal modules receive the control instructions generated by each of the virtual function modules through the bus and directly control respective loads based on the received control instructions.

2. The bus control system of claim 1, wherein at least some of the loads of the home appliance are shared by at least two different virtual function modules.

3. The bus control system of claim 2, wherein the loads of the home appliance include a plurality of execution components and a plurality of sensing components.

4. The bus control system of claim 3, wherein each of the virtual function modules obtains data of the plurality of execution components and the plurality of sensing components related to the corresponding function through the bus and generates corresponding control instructions based on the obtained data of the execution components and the sensing components.

5. The bus control system of claim 4, wherein the plurality of universal modules receive the control instructions generated by each of the virtual function modules through the bus and directly control respective execution components based on the received control instructions.

6. The bus control system of claim 1, wherein the home appliance is a washer, a refrigerator, or a dishwasher.

7. The bus control system of claim 6, wherein the plurality of virtual function modules include:
a water-level controlling module configured to provide a water level controlling function for controlling a water level in the washer;
a drying module configured to provide a drying function for drying clothes in the washer; and
a washing module configured to provide a washing function for washing clothes in the washer.

8. The bus control system of claim 7, wherein the water-level controlling module obtains data of a water inlet valve, a water level sensor, a gate lock, and a draining pump through the bus, and generates corresponding control instructions based on the obtained data.

9. The bus control system of claim 8, wherein the plurality of universal modules receive the control instructions generated by the water-level controlling module through the bus and directly control the water inlet valve, the gate lock, and the draining pump based on the received control instructions to control the water level in the washer.

10. The bus control system of claim 7, wherein the drying module obtains data of a temperature sensor, a drying heater, a drying fan, a gate lock, and a humidity sensor through the bus, and generates corresponding control instructions based on the obtained data.

11. The bus control system of claim 10, wherein the plurality of universal modules receive the control instructions generated by the drying module through the bus and directly control the drying heater, the drying fan, and the gate lock based on the received control instructions to dry clothes in the washer.

12. The bus control system of claim 7, wherein the washing module obtains data of a water level sensor, a gate lock, a water heater, a water temperature sensor and a motor through the bus, and generates corresponding control instructions based on the obtained data.

13. The bus control system of claim 12, wherein the plurality of universal modules receive the control instructions generated by the washing module through the bus and directly control the gate lock, the water heater, and the motor based on the received control instructions to wash clothes in the washer.

14. A bus control system for a home appliance, comprising:
a plurality of universal modules each connected to a bus and to at least one of a plurality of loads of the home appliance; and
a plurality of virtual function modules each communicated with the bus to perform a corresponding function, each of the virtual function modules obtains data of each of loads related to the corresponding function through the bus and generates corresponding control instructions based on the obtained data of each of the loads, and the plurality of universal modules receive the control instructions generated by each of the virtual function modules through the bus and directly control respective loads based on the received control instructions.

15. The bus control system of claim 14, wherein the plurality of loads of the home appliance are each physically connected to a nearest one of the plurality of universal modules.

16. The bus control system of claim 15, wherein at least some of the loads of the home appliance are shared by at least two different virtual function modules.
